(19) United States
(12) Patent Application Publication
(10) Pub. No.: US 2025/0272367 A1
(43) Pub. Date: Aug. 28, 2025

(54) IMAGE PROCESSING APPARATUS AND AUTHORIZATION METHOD IN IMAGE PROCESSING APPARATUS

(71) Applicant: Sharp Kabushiki Kaisha, Osaka (JP)

(72) Inventor: CHIKAKO TOMITA, Osaka (JP)

(21) Appl. No.: 19/055,742

(22) Filed: Feb. 18, 2025

(30) Foreign Application Priority Data
Feb. 26, 2024 (JP) 2024-026760

(51) Int. Cl. G06F 21/31

(52) U.S. Cl. CPC G06F 21/31

(57) ABSTRACT

An image processing apparatus includes a controller, a storage, and an outputter. The controller enables use of a plurality of authorization approaches to perform authorization processing with respect to an authorization server. The storage stores therein connection information for connection to the authorization server. The outputter outputs screen information related to the authorization processing. Upon a user selecting authorization processing based on one authorization approach using the connection information, the controller determines whether or not the authorization server supports the one authorization approach. Upon determining that the authorization server does not support the one authorization approach, the controller restricts execution of the authorization processing based on the one authorization approach, and the outputter outputs a notification prompting the user to select another authorization approach that is different from the one authorization approach.

### CROSS-REFERENCE TO RELATED APPLICATIONS

The present application claims priority from Japanese Application JP2024-026760, filed on Feb. 26, 2024, the content of which is hereby incorporated by reference into this application.

### BACKGROUND OF THE DISCLOSURE

### Field of the Disclosure

The present disclosure relates to an image processing apparatus and the like.

### Description of the Background Art

More secure authorization approaches, such as those based on the OAuth protocol, have been becoming mainstream authorization approaches for resource access.

A device flow approach known as an authorization approach based on the OAuth protocol is used to perform authorization of an image processing apparatus such as a multifunction peripheral via an external terminal device such as a personal computer (PC) or a smartphone through the web.

In the case of the device flow approach, the authorization of the image processing apparatus can be carried out without being constrained by factors such as whether or not the image processing apparatus has a browser, or an inputter for inputting authorization and authentication information.

However, some service providers providing OAuth authorization services do not support the device flow approach. In this case, it is impossible to execute authorization processing based on the device flow approach.

An object of the present disclosure is to provide an image processing apparatus and the like that makes it possible to reduce the risk that authorization processing is prevented from being implemented due to an authorization approach employed.

### SUMMARY OF THE DISCLOSURE

In order to solve the problems described above, the present disclosure provides an image processing apparatus including one or more controllers, a storage, and an outputter. The controllers enable use of a plurality of authorization approaches to perform authorization processing with respect to an authorization server. The storage stores therein connection information for connection to the authorization server. The outputter outputs screen information related to the authorization processing. Upon a user selecting authorization processing based on one authorization approach using the connection information, the controllers determine whether or not the authorization server supports the one authorization approach. Upon determining that the authorization server does not support the one authorization approach, the controllers restrict execution of the authorization processing based on the one authorization approach, and the outputter outputs a notification prompting the user to select another authorization approach that is different from the one authorization approach.

The present disclosure also provides an authorization method in an image processing apparatus that enables use of a plurality of authorization approaches to perform authorization processing with respect to an authorization server. The authorization method includes: determining, upon a user selecting authorization processing based on one authorization approach, whether or not the authorization server supports the one authorization approach; and restricting execution of the authorization processing based on the one authorization approach and outputting a notification prompting the user to select another authorization approach that is different from the one authorization approach, upon the authorization server being determined not to support the one authorization approach.

The present disclosure can provide an image processing apparatus and the like that makes it possible to reduce the risk that authorization processing is prevented from being implemented due to an authorization approach employed.

### BRIEF DESCRIPTION OF THE DRAWINGS

FIG. 1 is a diagram illustrating a form of connection of a service server and an external terminal device to a multifunction peripheral according to a first embodiment.

FIG. 2 is a diagram illustrating a functional configuration of the multifunction peripheral according to the first embodiment.

FIG. 3 is a diagram for describing a setting information table.

FIG. 4 is a flowchart for describing a flow of processing according to the first embodiment.

FIG. 5 is a diagram illustrating an authorization flow approach and a device flow approach.

FIGS. 6A and 6B are each a diagram illustrating an operation example according to the first embodiment.

FIGS. 7A and 7B are each a diagram illustrating an operation example according to the first embodiment.

FIG. 8 is a flowchart for describing a flow of processing according to a second embodiment.

FIGS. 9A and 9B are each a diagram illustrating an operation example according to the second embodiment.

FIG. 10 is a diagram illustrating an operation example according to a third embodiment.

FIG. 11 is a diagram illustrating an operation example according to the third embodiment.

### DESCRIPTION OF THE PREFERRED EMBODIMENTS

The following describes embodiments of the present disclosure with reference to the accompanying drawings. In the present disclosure, a multifunction peripheral capable of executing jobs related to, for example, copying, faxing, and e-mail transmission in a single housing is described as a form of the image processing apparatus according to the present disclosure. It should be noted that the embodiments below are presented as examples for describing the present disclosure, and the technical scope of the description as recited in the appended claims is not limited by the following description.

In addition to the device flow approach mentioned above, an authorization flow approach is also known as an authorization approach based on the OAuth protocol. The authorization flow approach uses a browser in the main body of the image processing apparatus to execute authorization processing. It is sometimes difficult to implement authorization processing using the device flow approach. In such cases, it is beneficial for users if the authorization processing can be continued through the main body of the image processing apparatus executing the authorization processing using the authorization flow approach.

It is therefore contemplated that a single image processing apparatus enables the use of different authorization approaches to implement authorization processing. For example, the authorization flow approach is employed in a case where authorization processing is executed using the main body of the image processing apparatus, and the device flow approach is employed in a case where authorization processing is executed using settings through the web. This configuration is expected to dramatically increase the throughput for authorization processing.

However, in the case of the aforementioned configuration, the usable service provider may vary depending on which approach is employed to execute authorization processing. Furthermore, there is a possibility that authorization processing cannot be executed using the authorization flow approach if the browser in the main body of the image processing apparatus becomes unusable due to some reasons such as the state of the main body of the image processing apparatus or the support period provided by the service provider. Thus, occasional failure to execute authorization processing depending on the state of the image processing apparatus, setting method, settings, or the like may cause confusion for users.

Through the following embodiments, the present disclosure allows for implementation of an image processing apparatus and the like that makes it possible to reduce the risk that authorization processing is prevented from being implemented due to an authorization approach employed.

### 1. First Embodiment

The following describes a multifunction peripheral 10 as a form of an image processing apparatus according to a first embodiment. However, the image processing apparatus is not limited to the multifunction peripheral 10, and may be, for example, a printer, a copier, or a fax machine where the types of job functions are limited.

### 1.1. Form of Connection

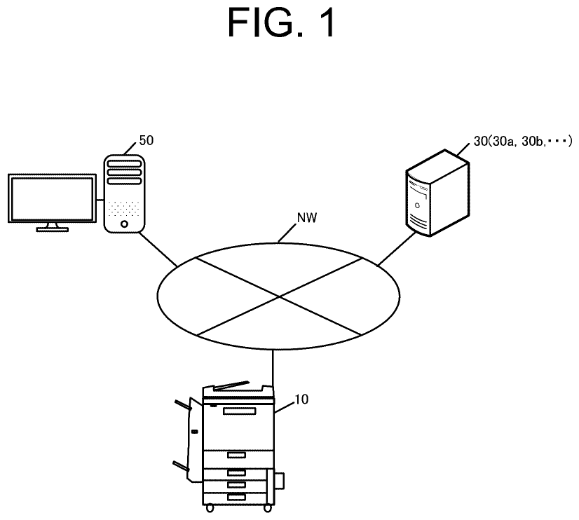

FIG. 1 is a diagram illustrating an example of a form of connection of a service server 30 (30a, 30b, . . . ) and an external terminal device 50 to the multifunction peripheral 10. The multifunction peripheral 10 is connected to the service server 30 (30a, 30b, . . . ) and the external terminal device 50 via a network NW in such a manner as to enable communication therebetween. It should be noted that the multifunction peripheral 10 according to the present disclosure can also function as a server device capable of outputting screen information related to job execution, various settings, authorization processing, or the like as a Web User Interface (Web-UI) to the external terminal device 50 or a browser of the multifunction peripheral 10 itself via, for example, a Web application using a communication protocol such as Hypertext Transfer Protocol (HTTP) or a native application, not shown.

The service server 30 (30a, 30b, . . . ) is an authorization server capable of executing authorization processing based on the OAuth protocol using at least one of an authorization flow approach or a device flow approach, or both. Here, lower-case letters (“a”, “b”) represent service servers 30 that are different in service specifications (for example, supported authorization approaches, browser requirements, and settings). The service server 30 is not limited to the two service servers 30a and 30b, and more than two service servers 30 may be involved. It should be noted that in the present disclosure, the service servers 30a and 30b may be referred to simply as the service server 30, provided that it is not necessary to distinguish between the service servers.

The external terminal device 50 is an information processing device capable of controlling the multifunction peripheral 10 through the web (application). The external terminal device 50 can perform operations related to job execution, various settings, authorization processing, and the like with respect to the multifunction peripheral 10 based on screen information outputted from the multifunction peripheral 10 functioning as the server device. In particular, the external terminal device 50 can receive authentication information inputted by a user and perform authentication processing between the external terminal device 50 and the service server 30 in the authorization processing using the device flow approach.

### 1.2. Functional Configuration

### 1.2.1. Multifunction Peripheral 10

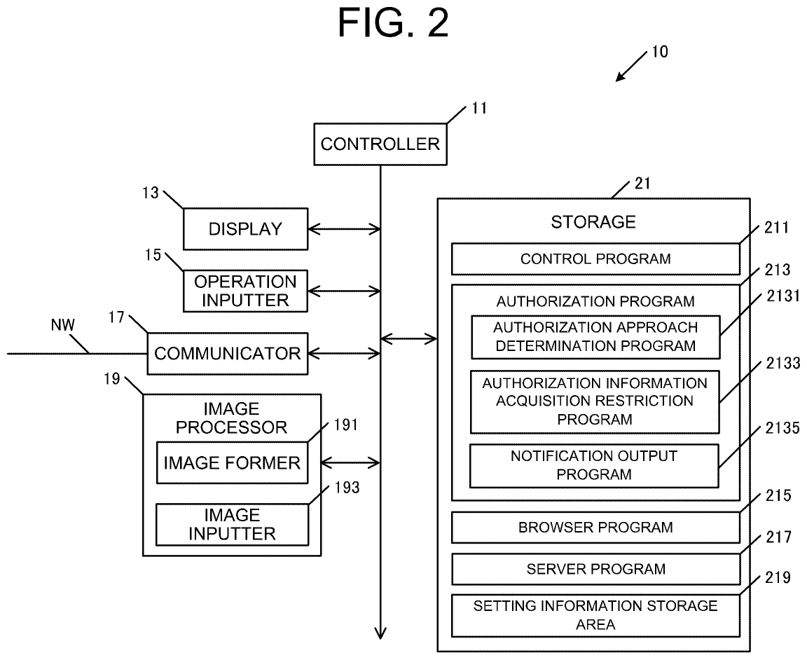

The following describes a functional configuration of the multifunction peripheral 10 with reference to FIG. 2. The multifunction peripheral 10 includes a controller 11, a display 13, an operation inputter 15, a communicator 17, an image processor 19, and a storage 21.

The controller 11 performs overall control of the multifunction peripheral 10. The controller 11 may include, for example, one or more processing devices (such as central processing units (CPUs) or Systems on Chip (SoCs)). The controller 11 reads various programs stored in the storage 21, and thus implements functions thereof.

The display 13 displays various types of information to a user. The display 13 may include, for example, a liquid crystal display (LCD) or an organic electro-luminescence (EL) display. The display 13 displays, based on the control by the controller 11, screen information of, for example, a home screen, not shown, and setting screens related to execution of jobs and authorization processing, via a browser screen described below.

The operation inputter 15 receives input of information by, for example, the user. The operation inputter 15 may include, for example, operation keys, such as hardware keys or software keys, and various input devices, such as buttons. The operation inputter 15 can be, for example, configured as a touch panel that allows input through a display device such as a liquid crystal display (LCD) or an organic electro-luminescence (EL) display. In a configuration in which the operation inputter 15 is a touch panel (may be referred to below as an “operation panel”), information indicating coordinates, pressure sensing, and the like on the operation panel can be obtained. In this configuration, the touch panel may adopt, for example, a common input method such as a resistive method, an infrared method, an inductive method, or a capacitive method.

The communicator 17 includes, for example, either or both of a wired interface and a wireless interface to communicate with the service server 30 and the external terminal device 50 via the network NW such as a local area network (LAN), a wide area network (WAN), the Internet, a telephone line, or a facsimile line. Furthermore, the communicator 17 may include, for example, an interface related to a wireless communication technique such as Bluetooth (registered trademark), Near Field Communication (NFC), Wi-Fi (registered trademark), Infrared Data Association (Irda), or wireless Universal Serial Bus (USB).

The image processor 19 includes an image former 191 and an image inputter 193. The image former 191 feeds paper from a paper feeder, not shown, forms an image on the paper based on image data, and then discharges the paper to a paper discharger, not shown. The image former 191 may include, for example, an electrophotographic laser printer. In this case, the image former 191 forms images using toners supplied from toner cartridges, not shown, corresponding to respective toner colors (for example, cyan, magenta, yellow, and black).

The image inputter 193 generates image data by scanning a document. The image inputter 193 may be, for example, configured as a scanner device that includes an image sensor such as a charge coupled device (CCD) or a contact image sensor (CIS) and has an automatic document feeder (ADF), a flatbed, on which the document is placed and read, and the like. No particular limitations are placed on the configuration of the image inputter 193 as long as the image inputter 193 is configured to read light reflected from a document image using an image sensor. The image inputter 193 can be, for example, configured as an interface that allows for acquisition of image data stored in a storage medium such as a USB flash drive or image data sent from the external terminal device 50. It should be noted that the image processor 19 may be, for example, configured to generate image data for image transmission by applying shading correction or density correction to image data inputted from the image inputter 193.

The storage 21 is one or more storage devices that store therein various programs necessary for operation of the multifunction peripheral 10 and various types of data. The storage 21 may include, for example, storage devices such as random access memory (RAM), a solid state drive (SSD), a hard disk drive (HDD), and read only memory (ROM).

In the first embodiment, the storage 21 stores therein a control program 211, an authorization program 213, a browser program 215, and a server program 217. In the storage 21, a setting information storage area 219 is reserved.

The controller 11 reads the control program 211 when comprehensively controlling the multifunction peripheral 10. The controller 11 that has read the control program 211 functions as an operating system (OS) and controls driving of hardware such as the display 13, the operation inputter 15, the communicator 17, and the image processor 19.

The controller 11 reads the authorization program 213 when executing authorization processing between the multifunction peripheral 10 and the service server 30. The controller 11 that has read the authorization program 213 can make an acquisition request for acquiring an authorization code and an access token issued by the service server 30, and make a request for a resource by presenting the access token acquired.

The authorization program 213 includes an authorization approach determination program 2131, an authorization information acquisition restriction program 2133, and a notification output program 2135. The controller 11 reads the authorization approach determination program 2131, and thus determines whether or not authorization processing based on an authorization approach selected by the user is executable. The controller 11 that has read the authorization approach determination program 2131 can determine, for example, whether or not the authorization processing based on the selected authorization approach is executable, based on whether or not the authorizing service server 30 supports the authorization approach selected by the user.

Upon determining that the authorization processing based on the authorization approach selected by the user is not executable, the controller 11 reads the authorization information acquisition restriction program 2133. The controller 11 that has read the authorization information acquisition restriction program 2133 restricts the execution of the authorization processing based on the selected authorization approach. In this case, for example, the controller 11 restricts acquisition (request) of authorization information by hiding a selection button that receives a request to the service server 30 for acquiring authorization information such as an authorization code and an access token or graying out the selection button being displayed, and thus disabling the selection button.

Furthermore, upon determining that the authorization processing based on the authorization approach selected by the user is not executable, the controller 11 reads the notification output program 2135. The controller 11 that has read the notification output program 2135 functions as an outputter and outputs a notification prompting the user to select another authorization approach that is different from the selected authorization approach, after restricting the execution of the authorization processing based on the selected authorization approach. Alternatively, upon determining that the authorization processing based on the authorization approach selected by the user is not executable, the controller 11 may read the authorization information acquisition restriction program 2133, and thus restrict the acquisition of authorization information after reading the notification output program 2135 and outputting a notification prompting the user to select another authorization approach that is different from the selected authorization approach.

The controller 11 reads the browser program 215 when rendering screen information so that the display 13 displays a screen for viewing. In the following description, the function that is implemented by the controller 11 that has read the browser program 215 may be referred to simply as a browser. The browser can display notifications and other information outputted through the notification output program 2135 via a browser screen displayed on the display 13.

The controller 11 reads the server program 217 when providing screen information in response to a request from a browser. The controller 11 that has read the server program 217 can implement a server function for outputting screen information in response to a request from the browser of the multifunction peripheral 10 or a browser of the external terminal device 50.

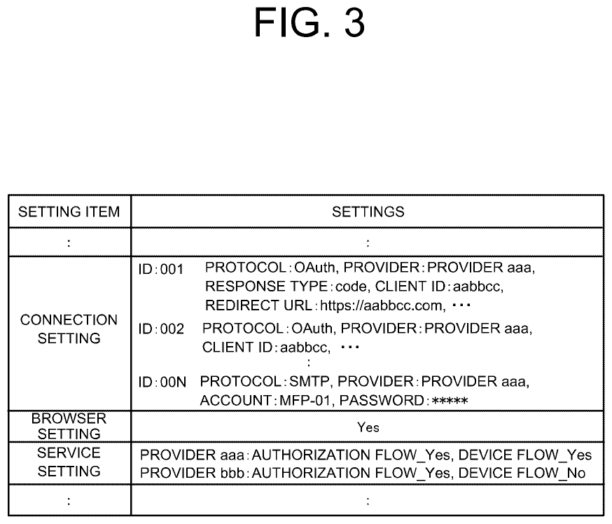

In the setting information storage area 219, setting information regarding apparatus settings of the multifunction peripheral 10 is stored. The following describes an example of the setting information stored in the setting information storage area 219 with reference to FIG. 3. FIG. 3 is a diagram showing an example of a setting information table for managing the setting information stored in the setting information storage area 219 on a per setting item basis. The setting information stored in the setting information storage area 219 may be managed in a database format instead of the table format.

The setting information table shown as an example in FIG. 3 contains various setting items. Among the setting items, connection setting, browser setting, and available service (service setting) are shown as examples. In addition to these setting items, needless to say, the setting information table contains other setting items as setting information to be managed, such as hardware setting and system setting.

The connection setting is, for example, a setting item regarding connection information for connection to terminal devices and services located on the network NW, such as the service server 30. “ID” herein is an identifier for uniquely identifying each set of connection information. For example, a set of connection information identified by an ID “001” includes settings such as a protocol “OAuth”, a provider “provider aaa”, a response type “Code”, a client ID “aabbcc”, and a redirect URL “https://aabbcc.com”. The set of connection information identified by the ID “001” is an example of request parameters included in an authorization request in the authorization flow approach. In a case where the authorization flow approach is employed as the authorization approach, the controller 11 sends an authorization request based on these request parameters to an authorization endpoint of the service server 30.

A set of connection information identified by an ID “002” includes settings such as a protocol “OAuth”, a provider “provider aaa”, and a client ID “aabbcc”. The set of connection information identified by the ID “002” is an example of request parameters included in an authorization request in the device flow approach. In a case where the device flow approach is employed as the authorization approach, the controller 11 sends an authorization request based on these request parameters to the authorization endpoint of the service server 30.

The connection setting may include connection information pertaining to any protocols other than the OAuth protocol. For example, a set of connection information identified by an ID “00N” is an example of connection information pertaining to the SMTP protocol.

The browser setting is setting information defining whether a browser function of the multifunction peripheral 10 is enabled or disabled. In the first embodiment, the value of the browser setting being “Yes” means that the browser function is enabled, and the value of the browser setting being “No” means that the browser function is disabled.

The available service (service setting) is a setting item defining an authorization service that can be provided by each service server 30, which is a provider. For example, the service server 30a, which functions as the provider aaa, can provide both an authorization service based on the authorization flow approach and an authorization service based on the device flow approach (authorization flow_Yes, device flow_Yes). For another example, the service server 30b, which functions as a provider bbb, can provide an authorization service based on the authorization flow approach (authorization flow_Yes) but cannot provide an authorization service based on the device flow approach (device flow_No).

The controller 11 that has read the authorization approach determination program 2131 can determine whether or not the authorization processing based on the authorization approach selected by the user is executable, by referring to a setting item (service setting) stored in the setting information storage area 219.

### 1.2.2. Service Server 30 (30a, 30b, . . . )

The service server 30 may have a known configuration as long as the configuration enables execution of authorization processing based on the OAuth protocol using at least one of the authorization flow approach or the device flow approach, or both. Description of the functional configuration of the service server 30 is therefore omitted. It should be noted that FIG. 1 shows the configuration of the service server 30 (30a, 30b, . . . ) as an independent device configuration capable of providing an authorization service(s). However, the service server 30 (30a, 30b, . . . ) may have a configuration capable of providing a cloud service, including a hardware configuration for providing resources based on authorization results in addition to the device configuration for providing an authorization service(s).

### 1.2.3. External Terminal Device 50

As the external terminal device 50, for example, an information processing device having a known configuration may be used, such as a PC, a smartphone, a tablet computer, or a cell phone. No particular limitations are placed on the configuration of the external terminal device 50, as long as the configuration has a browser program for generating a Web User Interface (Web-UI) by rendering screen information acquired via the server function provided by the multifunction peripheral 10. In a case where information such as user code information is provided from the multifunction peripheral 10 in the device flow authorization approach, the external terminal device 50 can access an authorization page using a hyperlink on the browser. Incidentally, for when user code information is provided as encoded information from the multifunction peripheral 10, the external terminal device 50 may include a decoder that acquires such encoded information from an imager such as a camera, not shown, and decodes the encoded information acquired. The encoded information herein may be a one-dimensional code such as a barcode (for example, EAN code, JAN code, Codbar, or CODE128), a two-dimensional code (stacked two-dimensional codes (for example, PDF417 or CODE49)), or a matrix two-dimensional code (for example, Quick Response Code (QR Code (registered trademark)), DataMatrix, VeriCode, or Aztec).

### 1.3. Flow of Processing

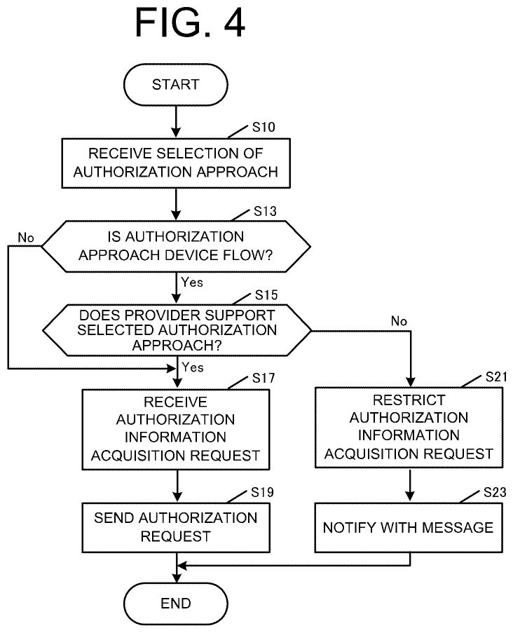

Next, the following describes a flow of processing according to the first embodiment. FIG. 4 is a flowchart for describing processing involved in reception of an authorization approach according to the first embodiment. The processing described with reference to FIG. 4 is executed through the controller 11 reading programs such as the control program 211, the authorization program 213 (the authorization approach determination program 2131, the authorization information acquisition restriction program 2133, and the notification output program 2135), the browser program 215, and the server program 217.

The controller 11 receives selection of an authorization approach based on whether selection has been inputted via a service setting screen displayed on the browser screen of the multifunction peripheral 10 or via a service setting screen displayed on the browser screen of the external terminal device 50, as described below (Step S10).

The controller 11 determines whether or not the received authorization approach is the device flow approach (Step S13). It should be noted that the controller 11 can determine that the authorization flow approach has been selected as the authorization approach if the controller 11 receives selection of a provider via the browser screen of the multifunction peripheral 10. On the other hand, the controller 11 can determine that the device flow approach has been selected as the authorization approach if the controller 11 receives selection of a provider via the browser screen of the external terminal device 50.

Upon determining that the received authorization approach is the device flow approach, the controller 11 determines whether or not the provider selected as an authorization server supports the device flow approach (Yes in Step S13-->Step S15). In this step, the controller 11 can determine whether or not the provider selected by the user supports the device flow approach by referring to an available service-related setting item (service setting) in the setting information table shown as an example in FIG. 3.

Upon determining that the received authorization approach is not the device flow approach, the controller 11 advances the processing to Step S17 (No in Step S13-->Step S17).

Upon determining that the provider selected by the user supports the device flow approach, the controller 11 receives an authorization information acquisition request (Yes in Step S15-->Step S17).

Upon receiving the authorization information acquisition request, the controller 11 sends an authorization request to the provider (service server 30) selected in Step S10 by referring to a setting item (connection setting) in the setting information table shown in FIG. 3, and ends the processing (Step S17-->Step S19).

Upon determining that the provider selected by the user does not support the device flow approach, the controller 11 restricts the authorization information acquisition request from being made (No in Step S15-->Step S21).

Subsequently, the controller 11 notifies the user with a message prompting the user to select another authorization approach (authorization flow approach) that is not the device flow approach as the authorization approach via, for example, the browser screen of the external terminal device 50, and ends the processing (Step S23).

### 1.4. Operation Example

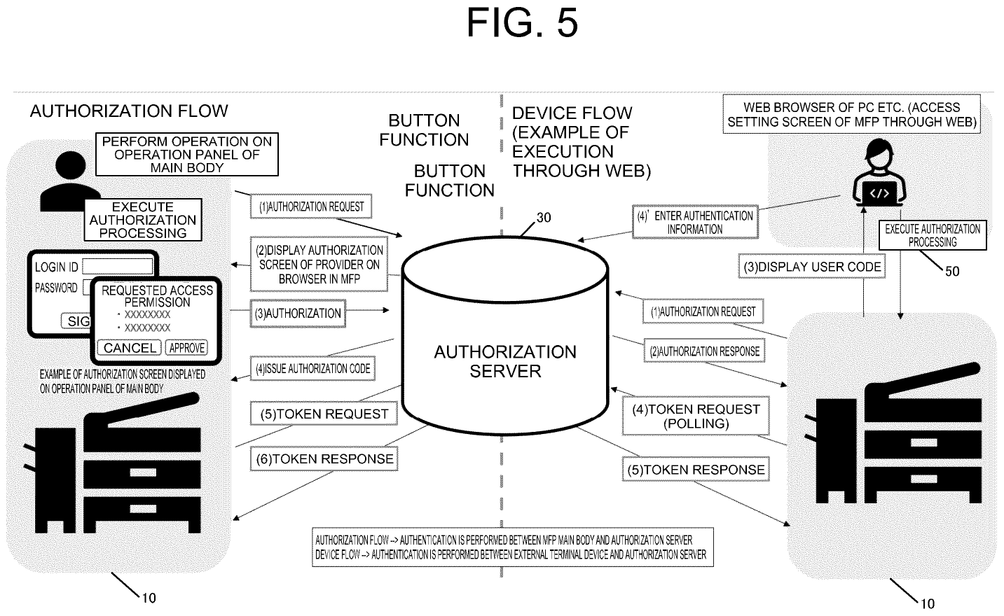

Before describing an operation example according to the first embodiment, the following describes the authorization flow approach and the device flow approach as authorization approaches according to the present disclosure with reference to FIG. 5.

FIG. 5 is a diagram illustrating exchange of commands and the like between the multifunction peripheral 10 and the service server 30 (30a, 30b, . . . ) selected as an authorization server in the case of the authorization flow approach (left part of FIG. 5) or in the case of the device flow approach (right part of FIG. 5). It should be noted that the following describes the service server 30 (30a, 30b, . . . ) that executes the authorization processing as an authorization server 30.

First, the authorization flow approach will be described. In the authorization flow, authorization (authentication) processing is performed between the multifunction peripheral 10 (browser screen displayed on the operation panel, which is an example of the display 13) and the authorization server 30.

Upon starting the authorization processing, the controller 11 sends an authorization request to an authorization endpoint, not shown, of the authorization server 30 (1).

The authorization endpoint of the authorization server 30 returns an authorization screen as an authorization response to a redirect URL (see FIG. 3) of the multifunction peripheral 10. Upon receiving the authorization screen, the multifunction peripheral 10 displays the authorization screen on the browser screen of the operation panel (2).

The user of the multifunction peripheral 10 enters authentication information such as his/her own login ID and password for the authorization server 30 via the authorization screen displayed on the browser screen, and approves the authorization request of the multifunction peripheral 10 (3).

Upon receiving the approval for the authorization request, an authorization decision endpoint, not shown, of the authorization server 30 issues an authorization code (4).

The multifunction peripheral 10 presents the issued authorization code to a token endpoint, not shown, of the authorization server 30 and requests an access token (5).

The token endpoint of the authorization server 30 checks the validity of the presented authorization code and issues an access token as a token response to the multifunction peripheral 10 (6).

Next, the device flow approach will be described. In the device flow, authorization (authentication) processing is performed between the external terminal device 50 (Web-UI, not shown) and the authorization server 30.

Upon the external terminal device 50 executing the authorization processing, the controller 11 of the multifunction peripheral 10 sends an authorization request to a device authorization endpoint, not shown, of the authorization server 30 (1).

The device authorization endpoint of the authorization server 30 returns a response including, for example, a device code, a user code, and a URL for end-user verification, not shown, to the multifunction peripheral 10 as an authorization response (2).

Upon receiving the authorization response, the multifunction peripheral 10 displays the user code and the URL for end-user verification included in the authorization response on the external terminal device 50 (3). In a case where the user code and the URL for end-user verification displayed are, for example, QR codes (registered trademark), the external terminal device 50 retrieves the user code and the URL for end-user verification by decoding the QR codes.

The external terminal device 50 that has acquired the user code and the URL for end-user verification accesses, via the browser, an end-user verification endpoint specified by the URL for end-user verification, and inputs the acquired user code in addition to authentication information such as the user's login ID and password (4)′.

The authorization server 30 verifies the authentication information and the user code inputted. If the verification of the authentication information and the user code is successful, the authorization server 30 returns, to the external terminal device 50, an authorization screen for the external terminal device 50 to confirm whether or not to approve the authorization request of the multifunction peripheral 10.

In the meantime, the multifunction peripheral 10 repeatedly sends access token acquisition requests through polling or other method after receiving the authorization response, and continues until the final result is obtained (4).

Upon the authorization request being approved via the authorization screen displayed on the Web-UI of the external terminal device 50, a token endpoint of the authorization server 30 returns an access token to the multifunction peripheral 10 as a token response (5).

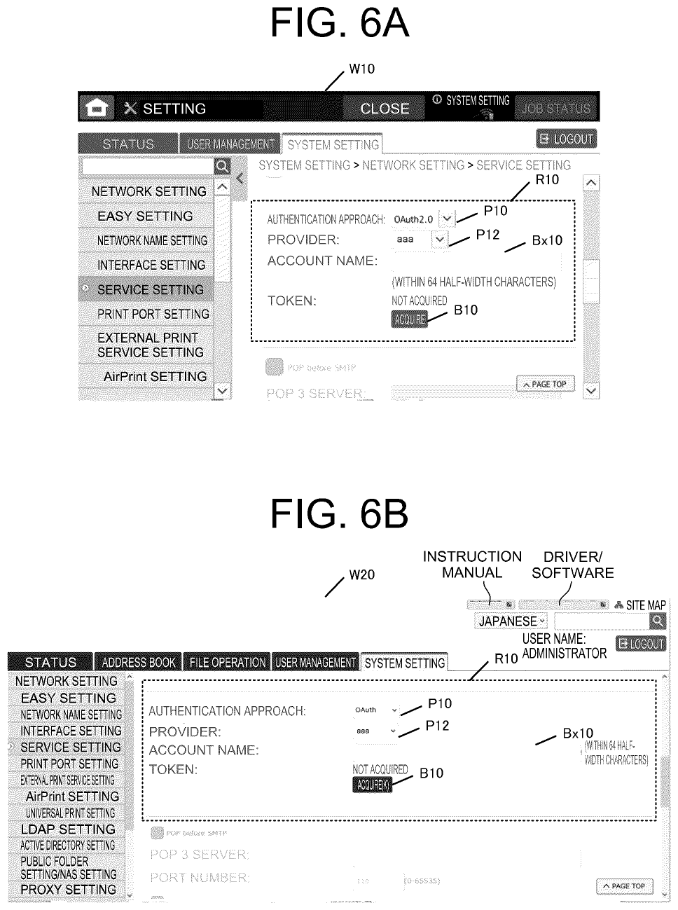

Next, the following describes a specific operation example according to the first embodiment. FIG. 6A is a diagram illustrating a configuration example of a service setting screen W10 displayed on the operation panel (browser screen) of the multifunction peripheral 10 as a screen corresponding to the authorization flow approach selected as the authorization approach. FIG. 6B is a diagram illustrating a configuration example of a service setting screen W20 displayed on the Web-UI of the external terminal device 50 as a screen corresponding to the device flow approach selected as the authorization approach. The service setting screen W10 shown in FIG. 6A and the service setting screen W20 shown in FIG. 6B may have the same configuration, and are therefore described using common reference signs.

The service setting screens W10 and W20 each include a provider setting area R10. The provider setting area R10 includes an authentication approach selection pull-down menu P10, a provider selection pull-down menu P12, an account name entry box Bx10, and a token acquisition button B10 as an authorization information acquisition request (mechanism).

The authentication approach selection pull-down menu P10 receives selection of a protocol for authorization (authentication) processing. In the examples shown in FIGS. 6A and 6B, OAuth 2.0 has been selected as the protocol. The provider selection pull-down menu P12 receives selection of a service server 30 (30a, 30b, . . . ) as a provider (authorization server). In the examples shown in FIGS. 6A and 6B, the “provider aaa” (see FIG. 3) has been selected as the provider. The account name entry box Bx10 receives entry of an account name for the provider (“provider aaa”) selected in the provider selection pull-down menu P12.

The token acquisition button B10 is a selection button that receives an instruction for acquiring an access token as authorization information. Upon receiving an instruction indicating selection of the token acquisition button B10, the controller 11 starts the authorization processing with respect to the provider (“provider aaa”) selected in the provider selection pull-down menu P12.

The service setting screen W20 shown as an example in FIG. 6B is a setting screen corresponding to the device flow approach selected as the authorization approach. Since the selected “provider aaa” supports the device flow approach (see FIG. 3), the controller 11 does not output a notification prompting the user to select another authorization approach, restrict the display of the token acquisition button B10, or change the manner in which the token acquisition button B10 is displayed.

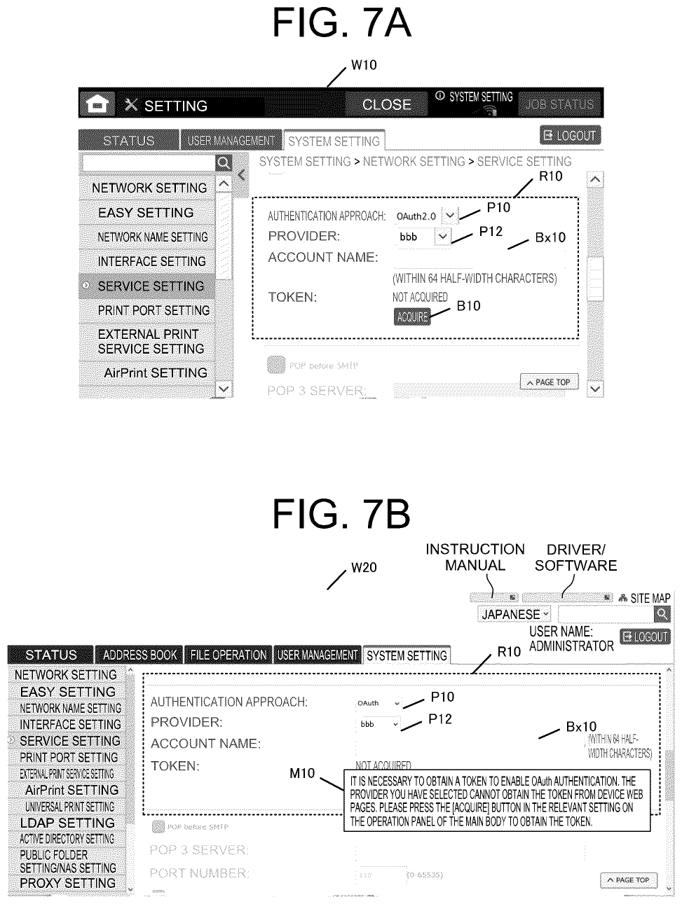

FIGS. 7A and 7B are diagrams showing examples in which the “provider bbb”, which does not support the device flow approach as the authorization approach, has been selected on the service setting screens W10 and W20 shown as examples in FIGS. 6A and 6B.

Since the service setting screen W10 displayed on the operation panel (browser screen) of the multifunction peripheral 10 in the example shown in FIG. 7A corresponds to the authorization flow approach, the controller 11 does not restrict the display of the token acquisition button B10 or change the manner in which the token acquisition button B10 is displayed even if the “provider bbb” is selected as the provider.

By contrast, the service setting screen W20 displayed on the Web-UI of the external terminal device 50 in the example shown in FIG. 7B corresponds to the device flow approach. Upon the “provider bbb” being selected as the provider, therefore, the controller 11 outputs a notification prompting the user to select another authorization approach, restricts the display of the token acquisition button B10, or changes the manner in which the token acquisition button B10 is displayed, for example.

In the example shown in FIG. 7B, the controller 11 has restricted the display of the token acquisition button B10 by superimposing a message M10, which prompts the user to select another authorization approach, on the token acquisition button B10. The message M10 is an example of a message screen that contains the following as a notification prompting the user to select another authorization approach: “It is necessary to obtain a token to enable OAuth authentication. The provider you have selected cannot obtain the token from device web pages. Please press the [Acquire] button in the relevant setting on the operation panel of the main body to obtain the token.”

According to the first embodiment, as described above, the controller determines whether or not the authorization server supports the device flow approach upon the user selecting authorization processing based on the device flow approach as an authorization approach using connection information. Upon determining that the authorization server does not support the device flow approach, the controller restricts execution of the authorization processing based on the device flow approach selected as the authorization approach and outputs a notification prompting the user to select the authorization flow approach as another authorization approach that is not the device flow approach. Thus, the first embodiment can provide an image processing apparatus and the like that makes it possible to reduce the risk that authorization processing is prevented from being implemented due to an authorization approach employed.

### 2. Second Embodiment

In some cases, a restriction is placed on the browser function. For example, the browser screen displayed on the operation panel of the multifunction peripheral 10 may be restricted from being used. In other cases, authorization processing based on the authorization flow is not allowed in the multifunction peripheral 10 due to the capability or an apparatus setting of the multifunction peripheral 10. In such cases, according to a second embodiment, either the authorization flow approach or the device flow approach is set as the authorization approach for the authorization server based on the capability or an apparatus setting of the multifunction peripheral 10.

Functional configurations of a multifunction peripheral 10, a service server 30 (30a, 30b, . . . ), and an external terminal device 50 according to the second embodiment may be the same as those according to the first embodiment. Description thereof is therefore omitted herein.

### 2.1. Flow of Processing

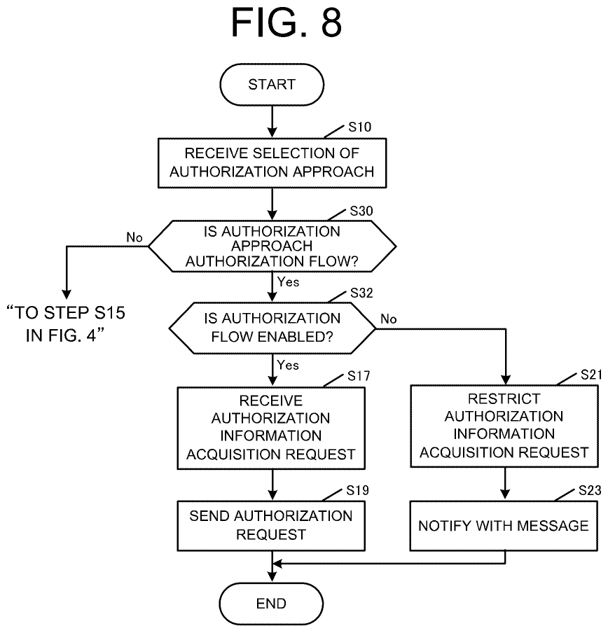

The flow of processing according to the second embodiment is represented by a flowchart shown in FIG. 8, which replaces the flowchart according to the first embodiment shown in FIG. 4. The same processes as those described with reference to FIG. 4 are therefore assigned the same step numbers as in FIG. 4, and description thereof is omitted.

The controller 11 determines whether or not the received authorization approach is the authorization flow approach (Step S30). Upon determining that the received authorization approach is the authorization flow, the controller 11 determines whether or not the authorization flow is enabled based on a setting (Yes in Step S30-->Step S32). Upon determining that the received authorization approach is not the authorization flow, the controller 11 advances the processing to Step S15 in FIG. 4 (No in Step S30-->“To Step S15 in FIG. 4”).

Upon determining that the authorization flow approach is enabled as an authorization approach based on a setting, the controller 11 receives an authorization information acquisition request (Yes in Step S32-->Step S17). Upon receiving the authorization information acquisition request, the controller 11 sends an authorization request to the provider (service server 30) selected in Step S10, and ends the processing (Step S17-->Step S19).

Upon determining that the authorization flow approach is not enabled as an authorization approach due to, for example, a restriction placed on the browser function or a setting prohibiting authorization processing based on the authorization flow in the multifunction peripheral 10, the controller 11 restricts the authorization information acquisition request from being made (No in Step S32-->Step S21).

Subsequently, the controller 11 notifies the user with a message prompting the user to select another authorization approach (device flow approach) that is not the authorization flow approach as the authorization approach via, for example, the operation panel (browser screen) of the multifunction peripheral 10, and ends the processing (Step S23).

### 2.2. Operation Example

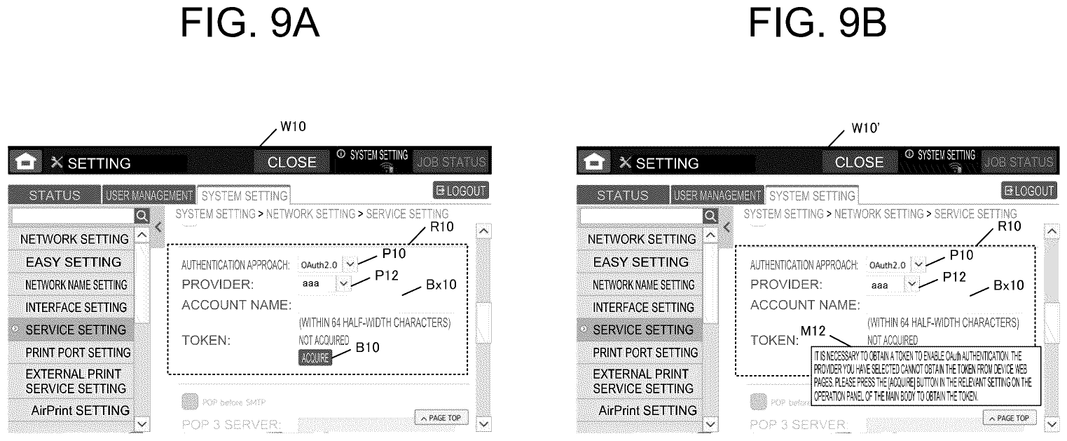

Next, the following describes an operation example according to the second embodiment. FIG. 9A is a diagram illustrating a configuration example of a service setting screen W10 displayed upon the controller 11 determining in Step S32 in FIG. 8 that the authorization flow approach is enabled as an authorization approach based on a setting. It should be noted that the service setting screen W10 shown as an example in FIG. 9A has the same configuration as the service setting screen W10 described with reference to FIG. 7A, and description thereof is omitted.

By contrast, FIG. 9B is a diagram illustrating a configuration example of a service setting screen W10′ displayed upon the controller 11 determining in Step S32 in FIG. 8 that the authorization flow approach is not enabled as an authorization approach based on a setting.

Upon the “provider aaa” being selected as the provider on the service setting screen W10′ shown as an example in FIG. 9B where the authorization flow approach is not enabled as an authorization approach, the controller 11 outputs a notification prompting the user to select another authorization approach, restricts the display of the token acquisition button B10, or changes the manner in which the token acquisition button B10 is displayed, for example.

In the example shown in FIG. 9B, the controller 11 has restricted the display of the token acquisition button B10 by superimposing a message M12, which prompts the user to select another authorization approach, on the token acquisition button B10. The message M12 is an example of a message screen that contains the following as a notification prompting the user to select another authorization approach: “It is necessary to obtain a token to enable OAuth authentication. Please obtain the token from a device WEB page.”

According to the second embodiment, as described above, the controller outputs a notification prompting the user to select the device flow approach as another authorization approach that is not the authorization flow approach upon determining that the authorization flow approach is not enabled as an authorization approach based on a setting. Thus, the second embodiment can provide an image processing apparatus and the like that makes it possible to reduce the risk that authorization processing is prevented from being implemented due to an authorization approach employed.

### 3. Third Embodiment

According to a third embodiment, it is possible to select either the authorization flow approach or the device flow approach as an authorization approach via the operation panel (browser screen) of the multifunction peripheral 10.

Functional configurations of a multifunction peripheral 10, a service server 30 (30a, 30b, . . . ), and an external terminal device 50, and the flow of processing according to the third embodiment may be the same as those according to the first embodiment or the second embodiment. Description thereof is therefore omitted herein.

### 3.1. Operation Example

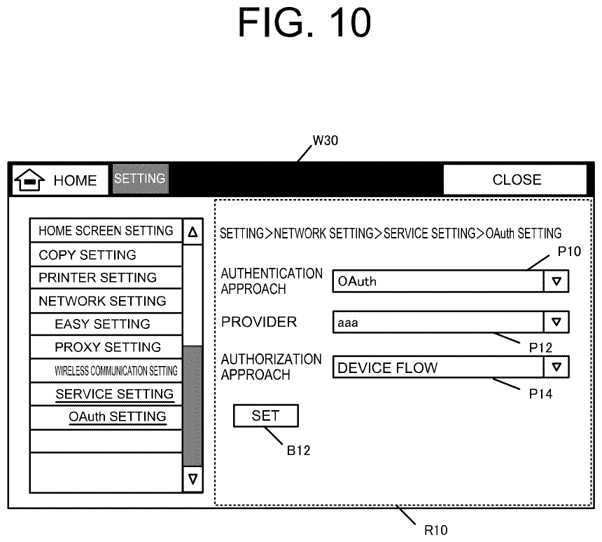

FIG. 10 is a diagram illustrating a configuration example of a service setting screen W30 according to the third embodiment. It should be noted that the same elements of configuration as in the service setting screen W10 described with reference to FIG. 6A or other drawings are labeled with the same reference signs as in the service setting screen W10, and description thereof is omitted.

The service setting screen W30 includes an authorization approach selection pull-down menu P14 and a set button B12 in addition to the configuration of the service setting screen W10.

The authorization approach selection pull-down menu P14 receives selection of an authorization approach. In the example shown in FIG. 10, the “device flow” approach has been selected as the authorization approach. The set button B12 is a selection button that receives an instruction for confirming a selection (input) operation in the provider setting area R10.

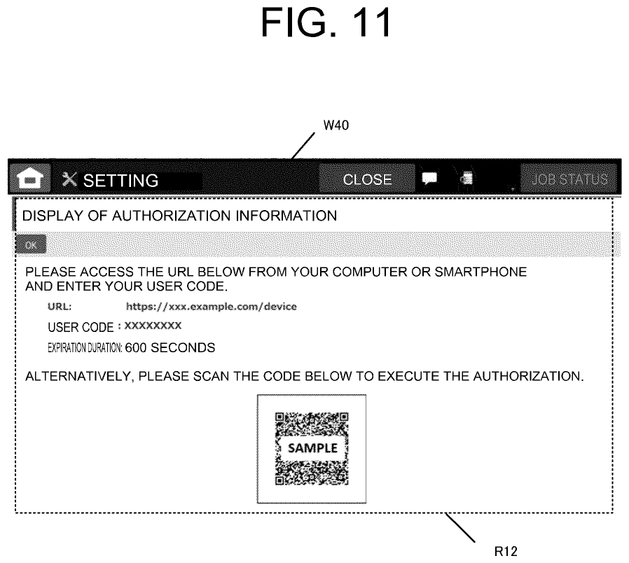

FIG. 11 is a diagram illustrating a configuration example of an authorization information display screen W40 displayed on the operation panel (browser screen) of the multifunction peripheral 10 upon the device flow approach being selected as the authorization approach via the operation panel. The authorization information display screen W40 includes an authorization information display area R12.

The user can enter an acquired user code in addition to authentication information such as his/her own login ID and password by accessing an end-user verification endpoint specified by a URL for end-user verification displayed in the authorization information display area R12 using, for example, an information processing device such as a smartphone or a tablet computer. The user may acquire the user code and the URL for end-user verification by reading QR codes (registered trademark) displayed in the authorization information display area R12.

According to the third embodiment, as described above, it is possible to select either the authorization flow approach or the device flow approach as an authorization approach via the operation panel (browser screen) of the multifunction peripheral 10. Having such an effect in addition to the effects of the first embodiment and the second embodiment, the third embodiment can provide an image processing apparatus and the like that offers further improved operability.

The present disclosure is not limited to the embodiments described above, and various modifications may be made thereto. That is, the technical scope of the present disclosure also includes embodiments that may be obtained by combining technical measures that are modified as appropriate without departing from the gist of the present disclosure.

Although some parts of the above-described embodiments are separately described for convenience of explanation, it is needless to say that the embodiments may be combined and implemented within a technically allowable range.

The program(s) that operates on each device (apparatus) in the foregoing embodiments is a program that controls the CPU or the like (program that causes a computer to function) so as to implement the functions according to the foregoing embodiments. Information that is handled by each device (apparatus) is temporarily accumulated in a temporary storage device (for example, RAM)) during processing, is then stored in various storage devices such as read only memory (ROM) and an HDD, and is read, corrected, and written by the CPU as needed.

A non-transitory computer-readable recording medium that records a program(s) in an information processing device as referred to herein may be, for example, any of a semiconductor medium (for example, ROM and a non-volatile memory card), an optical recording medium/magneto-optical recording medium (for example, Digital Versatile Disc (DVD)), a Magneto Optical Disc (MO), a Mini Disc (MD), a Compact Disc (CD), and a Blu-ray (registered trademark) Disc (BD)), and a magnetic recording medium (for example, a magnetic tape and a flexible disk). In this case, not only are the functions of the foregoing embodiments implemented through a computer of the image processing device reading and executing the program recorded on the recording medium, but the functions of the present disclosure may also be implemented through processing performed in cooperation with, for example, an operating system or other application programs based on instructions of the program.

For market distribution, the program may be stored and distributed in a portable recording medium or transferred to a server computer connected via a network such as the Internet. In this case, a storage device of the server computer is obviously included in the present disclosure.

Furthermore, the functional blocks or various features of the device/apparatus used in the embodiments described above may be implemented or executed as an electrical circuit, such an integrated circuit or a plurality of integrated circuits. An electrical circuit designed to implement the functions described herein may include a general-purpose processor, a digital signal processor (DSP), an application-specific integrated circuit (ASIC), a field programmable gate array (FPGA), or other programmable logic devices, discrete gates or transistor logic, discrete hardware components, or a combination of these. The general-purpose processor may be a microprocessor or a conventional processor, controller, microcontroller, or state machine. The electrical circuit described above may be configured by a digital circuit or an analog circuit. Moreover, when an integrated circuit technology that replaces the current integrated circuits emerges as a result of advances in semiconductor technology, one or more aspects of the present disclosure may also use the new integrated circuits based on such technology.

What is claimed is:

1. An image processing apparatus comprising:
one or more controllers that enable use of a plurality of authorization approaches to perform authorization processing with respect to an authorization server;
a storage that stores therein connection information for connection to the authorization server; and
an outputter that outputs screen information related to the authorization processing, wherein
upon a user selecting authorization processing based on one authorization approach using the connection information, the controllers determine whether or not the authorization server supports the one authorization approach, and upon determining that the authorization server does not support the one authorization approach, the controllers restrict execution of the authorization processing based on the one authorization approach, and
the outputter outputs a notification prompting to select another authorization approach that is different from the one authorization approach.

2. The image processing apparatus according to claim 1, wherein the controllers restrict an authorization information acquisition request to the authorization server from being made as a way of restricting execution of the authorization processing based on the one authorization approach.

3. The image processing apparatus according to claim 1, wherein the controllers set either the one authorization approach or the different authorization approach as an authorization approach for the authorization server based on capability or an apparatus setting of the image processing apparatus.

4. The image processing apparatus according to claim 1, wherein the controllers receive the user's selection of the one authorization approach or the different authorization approach as an authorization approach for the authorization server.

5. The image processing apparatus according to claim 1, wherein the one authorization approach is an authorization approach that involves authentication between the image processing apparatus and the authorization server, and the different authorization approach is an authorization approach that involves authentication between an external terminal device and the authorization server.

6. An authorization method in an image processing apparatus that enables use of a plurality of authorization approaches to perform authorization processing with respect to an authorization server, the authorization method comprising:
determining, upon a user selecting authorization processing based on one authorization approach, whether or not the authorization server supports the one authorization approach; and
restricting execution of the authorization processing based on the one authorization approach and outputting a notification prompting to select another authorization approach that is different from the one authorization approach, upon the authorization server being determined not to support the one authorization approach.
